(19) United States
(12) Patent Application Publication
(10) Pub. No.: US 2024/0123678 A1
(43) Pub. Date: Apr. 18, 2024

(54) SYNTHETIC RESIN ARTICLE AND METHOD OF FABRICATION THEREOF

(71) Applicant: NEOLT ASIA PTE. LTD., Singapore (SG)

(72) Inventor: Kok Leong CHEAH, Singapore (SG)

(21) Appl. No.: 18/339,226

(22) Filed: Jun. 21, 2023

Related U.S. Application Data
(63) Continuation of application No. PCT/SG2021/050048, filed on Feb. 1, 2021.

(30) Foreign Application Priority Data
Dec. 21, 2020 (SG) 10202012815W

(51) Int. Cl. B29C 64/112; A44B 1/02; A44B 1/04; B29C 64/188; B29C 64/245; B29C 64/264; B29C 64/386; B29D 19/00; B33Y 10/00; B33Y 40/20; B33Y 50/00; B33Y 80/00; B41M 3/00; B41M 5/00; B41M 7/00; C09J 7/29; C09J 7/38

(52) U.S. Cl. CPC B29C 64/112; A44B 1/02; A44B 1/04; B29C 64/188; B29C 64/245; B29C 64/264; B29C 64/386; B29D 19/00; B33Y 10/00; B33Y 40/20; B33Y 50/00; B33Y 80/00; B41M 3/008; B41M 5/0023; B41M 7/0045; B41M 7/0081; C09J 7/29; C09J 7/38; B29K 2995/00; B29K 2995/0097; B29L 2019/00

(57) ABSTRACT

A synthetic resin article is disclosed that comprises a layer of digitally inkjet-printed and ultraviolet light (UV)-cured synthetic resin. The synthetic resin article has a thickness ranging from 0.5 mm to 15 mm. The synthetic resin article is free from any substrate supporting the layer of digitally inkjet-printed and UV-cured synthetic resin.

### CROSS-REFERENCE TO RELATED APPLICATIONS

The present application is a bypass continuation of International Application No. PCT/SG2021/050048, filed Feb. 1, 2021, entitled “SYNTHETIC RESIN ARTICLE AND METHOD OF FABRICATION THEREOF,” which claims priority to Singapore Application No. 10202012815W filed with the Intellectual Property Office of Singapore on Dec. 21, 2020, both of which are incorporated herein by reference in their entirety for all purposes.

### FIELD

This invention relates to a synthetic resin article and method of fabrication thereof, and in particular, to a synthetic resin article fabricated by digital inkjet printing.

### BACKGROUND

Conventional methods of fabricating synthetic resin articles such as buttons, badges, tags for keychains and so on typically comprise casting or moulding (including injection moulding) the synthetic resin, followed by curing of the synthetic resin to harden it. These processes are time-consuming and also often require elevated temperatures and/or pressures. In many cases, such as for buttons, further steps are needed to finish the article, such as cutting the synthetic resin sheet from a drum before it is fully cured, curing the sheet, punching blanks in the sheet, turning the blanks to form the desired shape, drilling through holes and finally polishing the button. It is therefore desirable to be able to fabricate synthetic resin articles including buttons in a faster and more cost-effective way that does not require heavy up-front capital investment in specialised expensive machinery and processes.

### SUMMARY

According to a first aspect, there is provided a synthetic resin article comprising: a layer of digitally inkjet-printed and ultraviolet light (UV)-cured synthetic resin, the synthetic resin article having a thickness ranging from 0.5 mm to 15 mm and being free from any substrate supporting the layer of digitally inkjet-printed and UV-cured synthetic resin.

The synthetic resin article may further comprise a decorative layer provided on the layer of digitally inkjet-printed and UV-cured synthetic resin.

The decorative layer may comprise a decorative foil hot-stamped on a bottom surface of the layer of digitally inkjet-printed and UV-cured synthetic resin.

The synthetic resin article may comprise two layers of digitally inkjet-printed and UV-cured synthetic resin, wherein the decorative layer may comprise a decorative foil hot stamped on a top surface of a first of the two layers of digitally inkjet-printed and UV-cured synthetic resin, and a second of the two layers of digitally inkjet-printed and UV-cured synthetic resin digitally printed and UV-cured on a top surface of the layer of decorative foil.

The decorative layer may comprise a decorative image digitally inkjet-printed on a top surface of the layer of digitally inkjet-printed and UV-cured synthetic resin.

The synthetic resin article may further comprise a further layer of digitally inkjet-printed and UV-cured synthetic resin digitally printed and UV-cured on a top surface of the decorative image.

The synthetic resin article may further comprise a plurality of through holes and configured as a button.

A bottom surface of the synthetic resin article may be provided with a layer of hot melt adhesive film for adhering the synthetic resin article to textile by application of heat.

The synthetic resin article may be pliable.

According to a second aspect, there is provided a method of fabricating a synthetic resin article, the method comprising:
a) providing a flatbed digital inkjet printer with a digital image file for printing with UV-curable synthetic resin ink;
b) providing a non-stick surface on the flatbed digital inkjet printer;
c) digitally inkjet printing a layer of UV-curable synthetic resin ink on the non-stick surface according to the digital image file;
d) UV curing the printed layer of UV-curable synthetic resin ink to form a layer of digitally inkjet-printed and UV-cured synthetic resin; and
e) removing the layer of digitally inkjet-printed and UV-cured synthetic resin from the non-stick surface to obtain the synthetic resin article that is free from any substrate supporting the layer of digitally inkjet-printed and UV-cured synthetic resin.

The digital image file may be obtained by 3D scanning an existing article that is to be replicated in the synthetic resin article.

Step a) may comprise providing a number of digital image files for printing with UV-curable synthetic resin ink, and steps c) and d) are performed a number of times corresponding to the number of digital image files.

Each digital image file may specify a number of times that an image in the digital image file is to be printed in order to form a required thickness of the synthetic resin article, wherein steps c) and d) are performed a number of times corresponding to the specified number of times.

The method may further include, after step d), fabricating a decorative layer on the layer of digitally inkjet-printed and UV-cured synthetic resin.

Fabricating the decorative layer may comprise providing the flatbed digital inkjet printer with a digital decorative image file containing a decorative image for printing with colour ink and digitally inkjet printing the decorative image on the layer of digitally inkjet-printed and UV-cured synthetic resin.

The method may further comprise repeating steps c) and d) to fabricate a further layer of digitally inkjet-printed and UV-cured synthetic resin over the digitally inkjet-printed decorative image.

Fabricating the decorative layer may comprise hot stamping a decorative foil on the layer of digitally inkjet-printed and UV-cured synthetic resin.

Hot stamping the decorative foil may be performed on a bottom surface of the layer of digitally inkjet-printed and UV-cured synthetic resin.

Hot stamping the decorative foil may be performed on a top surface of the layer of digitally inkjet-printed and UV-cured synthetic resin and the method further may comprise repeating steps c) and d) to fabricate a further layer of digitally inkjet-printed and UV-cured synthetic resin over the hot-stamped decorative foil.

A part of the non-stick surface may be contoured according to a design of the synthetic resin article to be fabricated and step c) is performed on the contoured part.

The digital image file for printing with UV-curable synthetic resin ink may comprise a grayscale image and wherein ink intensity of UV-curable synthetic resin ink that is deposited in step c) is directly proportional to grayscale intensity of the part of the grayscale image that is being printed.

### BRIEF DESCRIPTION OF FIGURES

In order that the invention may be fully understood and readily put into practical effect, there shall now be described by way of non-limitative example only embodiments of the present invention, the description being with reference to the accompanying illustrative drawings.

FIG. 1 is a top view of a first exemplary embodiment of a synthetic resin article having the form of a first button.

FIG. 2 is a side view (showing hidden lines) of the button of FIG. 1.

FIG. 3 is a schematic illustration of a digital image file for printing the button of FIG. 1.

FIG. 4 is a top view of second first exemplary embodiment of a synthetic resin article having the form of a second button.

FIG. 5 is a side view (showing hidden lines) of the button of FIG. 4.

FIG. 6 is a schematic illustration of a first image in a first digital file for printing a first synthetic resin layer of the button of FIG. 4.

FIG. 7 is a schematic illustration of a second image in a second digital image file for printing a decorative image layer of the button of FIG. 4.

FIG. 8 is a schematic illustration of a third image in a third digital image file for printing a second synthetic resin layer of the button of FIG. 4.

FIG. 9 is a flow chart of an exemplary method of forming a synthetic resin article.

### DETAILED DESCRIPTION

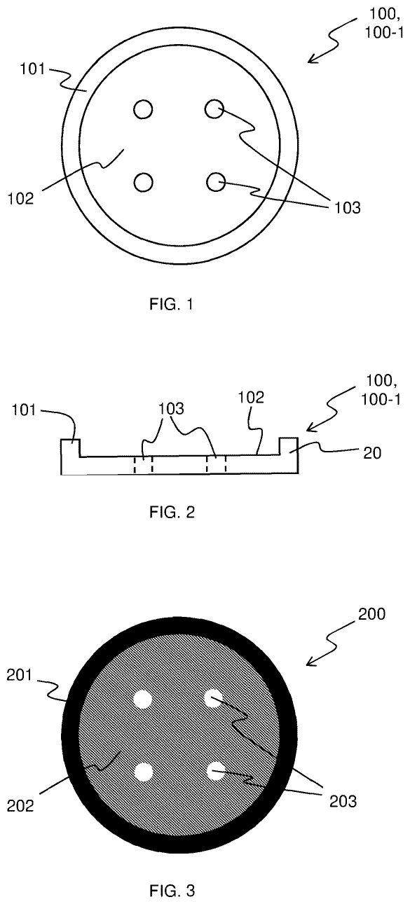

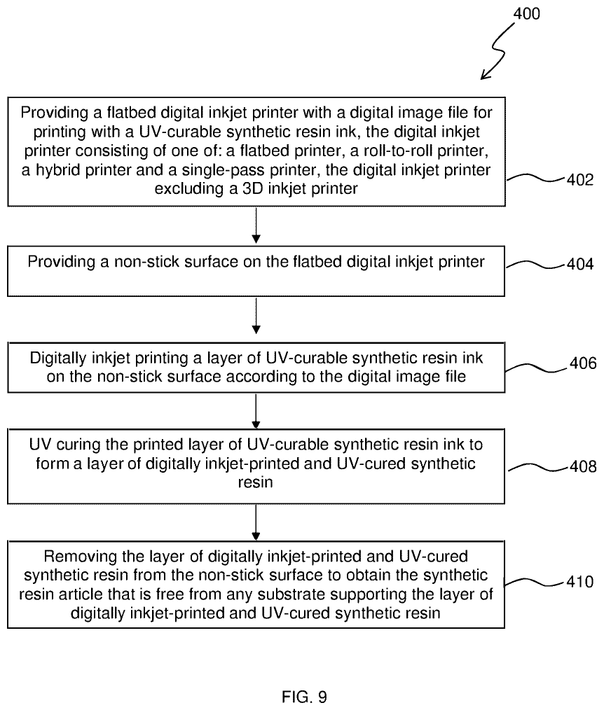

Exemplary embodiments of a synthetic resin article 100 and a method 400 of fabrication of the synthetic resin article 100 will be described below with reference to FIGS. 1 to 9. The same or similar reference numerals are used across the figures to denote the same or similar parts.

In general, the presently disclosed synthetic resin article 100 comprises at least one layer of digitally inkjet-printed and ultraviolet light (UV) cured synthetic resin 20 that is fabricated using at least one UV-curable synthetic resin ink. The at least one UV-curable synthetic resin ink may comprise a polyurethane (PU) or polymethylmethacrylate (PMMA) ink that is inkjet printable, for example, among other digitally inkjet-printable synthetic resins. The synthetic resin article 100 is free from any substrate supporting the one or more digitally inkjet-printed UV-cured synthetic resin 20 layers of the article 100. The synthetic resin article 100 may have a thickness ranging from 0.5 mm to 15 mm.

Embodiments of the synthetic resin article 100 include buttons, rhinestones, badges, decorative embosses for textile including articles such as clothing and bags, and tags for keychains, for example. A first exemplary embodiment of the synthetic resin article 100 comprises a first button 100-1 as shown in FIGS. 1 and 2. The first button 100-1 is generally circular with a raised or thickened circumference 101 and a thinner central portion 102 that is provided with a plurality of through holes 103. The first button 100-1 comprises a single layer 20 of digitally inkjet-printed UV-cured synthetic resin. Appreciably, the single layer of UV-cured synthetic resin 20 has different thickness across the profile of the first button 100-1, as can be seen in FIG. 2.

The single layer of UV-cured synthetic resin 20 that forms the first button 100-1 can be digitally inkjet-printed by providing an appropriately configured digital inkjet printer not shown) with an appropriate digital image file for printing with a UV-curable synthetic resin ink. The digital inkjet printer may be of any appropriate type, including hybrid printers, single pass printers, roll-to-roll printers, for example. The digital image file may be of any appropriate image file format such as JPEG, TIFF, EPS, PDF, PSD and so on that will be accepted by a raster image processor (RIP) of the digital inkjet printer. The digital image file comprises a grayscale image 200, as shown in FIG. 3. The digital inkjet printer is calibrated to receive digital image file and print the grayscale image 200, wherein the grayscale intensity of the grayscale image 200 is directly proportional to the ink intensity of UV-curable synthetic resin ink that is digitally inkjet-printed by the digital inkjet printer to fabricate the first button 100-1. Ink intensity during printing is directly proportional to the thickness of the layer of the UV-cured synthetic resin 20 that is printed.

For example, maximum ink intensity may be calibrated to correspond to maximum grayscale intensity (i.e., black) and minimum ink intensity (i.e., no ink being deposited) may be calibrated to correspond to minimum grayscale intensity (i.e. white). In this way, where the UV-curable synthetic resin ink is printed with maximum intensity according to the maximum grayscale intensity 201 of the grayscale image 200, a maximum thickness of the layer of UV-cured synthetic resin 20 is digitally inkjet-printed to form the raised circumference 101 of the first button 100-1. Similarly, where the grayscale intensity is at zero 203 in the grayscale image 200, no ink is deposited, thus forming the through holes 103 in the first button 100-1. Printing the areas of 50% grayscale intensity 202 of the grayscale image 200 results in the fabrication of the thinner central portion 102 of the first button 100-1 that has a thickness of half the thickness of the raised edge 101 of the first button 100-1.

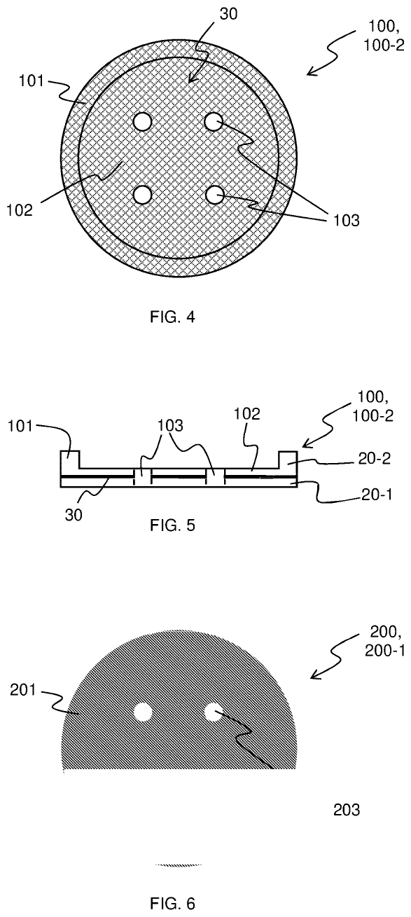

In some embodiments, in addition to the at least one layer of digitally inkjet-printed UV-cured synthetic resin 20, the synthetic resin article 100 may further comprise a decorative layer 30. For example, in a second exemplary embodiment of the synthetic resin article 100 that comprises a second button 100-2 as shown in FIGS. 4 and 5, the decorative layer 30 may comprise a digitally inkjet-printed decorative image 300 that is printed over the at least one layer of digitally inkjet-printed UV-cured synthetic resin 20 for a decorative visual effect. For example, the decorative image 300 may comprise a colour image and/or provide a textured effect such as an embossed logo of a brand. In the second exemplary embodiment, like the first button 100-1, the second button 100-2 is generally circular with a raised or thickened circumference 101 and a thinner central portion 102 that is provided with a plurality of through holes 103. However, the second button 100-2 includes a decorative layer 30 that comprises a digitally inkjet-printed image 300 that is visible under a top layer of synthetic resin 20.

Structurally, the second button 100-2 comprises a first or bottom layer of digitally inkjet-printed UV-cured synthetic resin 20-1, a digitally inkjet-printed image 300 that is printed over the first layer of synthetic resin 20-1, and a second or top layer of digitally inkjet-printed UV-cured synthetic resin 20-2 that is printed over the digitally inkjet-printed image 300. The image 300 is thus sandwiched between two layers of UV-cured synthetic resin 20-1, 20-2. The second layer of UV-cured synthetic resin 20-2 is transparent or translucent so that the image 300 can be seen through it. In this way, the image 300 is protected by the layers of UV-cured synthetic resin 20-1, 20-2, thus prolonging the durability of colour of the image 300.

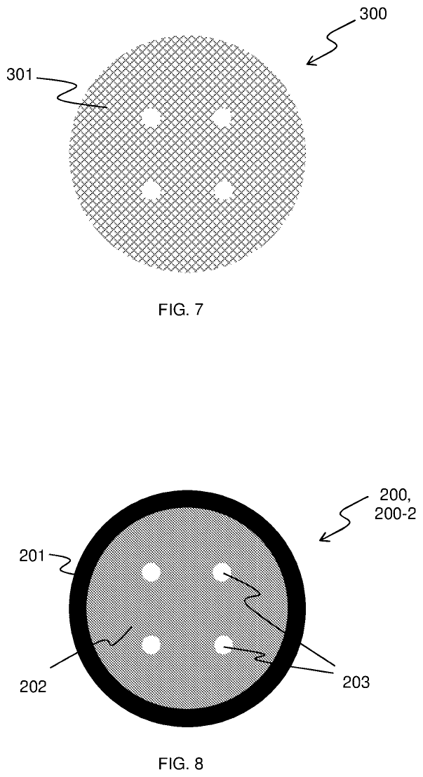

Each layer 20-1, 30, 30-2 of the second button 100-2 can be digitally inkjet-printed by providing an appropriately configured flatbed digital inkjet printer (not shown) with an appropriate digital image file 200, 300. For printing the first and second UV-cured synthetic resin layers 20-1, 20-2, grayscale images 200-1, 200-2 as shown in FIGS. 6 and 8 respectively may be used wherein the grayscale intensity in these images 200-1, 200-2 is directly proportional to the ink intensity during digital printing that is in turn directly proportional to the thickness of the layer of UV-cured synthetic resin 20-1, 20-2 that is printed. As can be seen in FIG. 6, the image 200-1 for printing the bottom layer of UV-cured synthetic resin 20-1 has a uniform 50% grayscale intensity across the circular area 201 of the second button 200, with the exception of areas of white or 0% grayscale intensity for forming the through holes 103 in the second button 100-2. In this way, the first layer of UV-cured synthetic resin 20-1 in the second button 100-2 has a uniform thickness. The decorative image 300 that is to be visible (shown in FIG. 7) is then printed over the first layer of UV-cured synthetic resin 20-1. The top layer of UV-cured synthetic resin 20-2 is printed over the image 300 from a grayscale image 200-2 as shown in FIG. 8 that is similar to the grayscale image 200 shown in FIG. 3 that is used to print the first button 100. Thus, as can be seen in FIG. 5, the top layer of UV-cured synthetic resin 20-2 has different thickness across the profile of the second button 100-2, similar to that of the first button 100-1.

Appreciably, depending on the desired design of the synthetic resin article 100, the article 100 may comprise one or more layers of UV-cured synthetic resin 20, with or without one or more decorative layers 30 provided therebetween or thereon. Notably, the one or more decorative layers need not comprise digitally printed decorative images, but can have other forms such as decorative foil. For example, another exemplary embodiment of the synthetic resin article 100 comprises a rhinestone (not shown). The rhinestone embodiment of the article 100 may comprise a layer of decorative foil that is hot-stamped onto a first flat layer of digitally inkjet-printed UV-cured synthetic resin 20 and a second faceted layer of UV-cured synthetic resin 20 that is digitally inkjet-printed over the hot-stamped foil. In an alternative rhinestone embodiment of the article 100, the rhinestone may comprise decorative foil hot-stamped onto the flat bottom surface of a faceted layer of digitally inkjet-printed UV-cured synthetic resin 20.

Badges and decorative embosses for textiles may similarly comprise a decorative layer comprising a digitally printed image or metallic foil formed on a bottom thin layer of digitally inkjet-printed UV-cured synthetic resin (for example with a thickness of 25-100 microns) and protected with a top layer of digitally inkjet-printed UV-cured synthetic resin. Such articles 100 are preferably pliable and can be configured to be so by using one or more appropriate UV-curable synthetic resin ink that remains pliable after it is fully cured.

Synthetic resin articles 100 for use with textiles may additionally comprise a layer of hot melt adhesive film provided on a bottom surface of the article 100 for adhering the article 100 to textile by the application of heat. Alternatively, the synthetic resin article 100 may be adhered to textile using PU glue.

In other embodiments, the layer of decorative image may be a top surface or layer of the synthetic resin article 100, without being covered over by another layer of UV-cured synthetic resin.

In an exemplary method 400 of fabricating the synthetic resin article 100, a flatbed digital inkjet printer (not shown) is used. For all embodiments, preferably, a non-stick surface (not shown) is provided on a flat printing bed of the printer. By fabricating a bottom layer of digitally inkjet-printed UV-cured synthetic resin 20 on the non-stick surface, the article 100 may be readily removed from the non-stick surface. The article 100 or may not comprise further layers of UV-cured synthetic resin 20 or other decorative layers 300. The non-stick surface itself may be flat or contoured according to the shape of the article 100 to be printed.

For example, by providing a concave depression on the non-stick surface for printing a button thereon, the layer of UV-cured synthetic resin that is printed into the concave depression to fabricate the button will take the shape of the depression. In this way, the bottom surface of the resulting button will have a corresponding convex surface.

The method 400 thus comprises at least the steps of:
a) providing a non-stick surface on the printer 402
b) providing the printer with a digital image file for printing with UV-curable synthetic resin ink 404;
c) digitally inkjet printing a layer of UV-curable synthetic resin ink on the non-stick surface 406;
d) UV curing the printed layer of UV-curable synthetic resin ink to form a layer of digitally inkjet-printed and UV-cured synthetic resin 408; and
e) removing the layer of digitally inkjet-printed and UV-cured synthetic resin from the non-stick surface 410.

The digital image file may be graphically prepared, or may be obtained by 3D scanning an existing article that is to be replicated in the synthetic resin article 100. For example, a METIS SURF 3D scanner may be used to scan the existing article to obtain a data file (TIFF format) that can be processed by the raster image processor of the digital inkjet printer and printed directly to form the synthetic resin article 100.

Notably, steps c) and d) of printing and curing the layer of UV-curable synthetic resin may be performed a number of times to form a corresponding number of layers of UV-cured synthetic resin according to a number of times that an image in the digital image file is specified to be printed in order to form a required thickness of the synthetic resin article 100. Appreciably, more than one distinct digital image file may be provided wherein for each distinct digital image file, steps c) and d) may be performed according to the number of times that each image in the distinct digital image file is specified to be printed.

If desired, the method 200 may further include fabricating a decorative layer on the layer of UV-cured synthetic resin after step d) before removing it from the non-stick surface in step e). If more than one layer of UV-cured synthetic resin layer formed, the decorative layer may be fabricated between two layers of UV-cured synthetic resin.

Fabricating the decorative layer may comprise digitally inkjet printing a decorative image from a digital image file on the layer of digitally inkjet-printed UV-cured synthetic resin, or may alternatively comprise hot stamping decorative foil on the layer of digitally inkjet-printed UV-cured synthetic resin. As described above for articles 100 comprising rhinestones, the hot stamping may be performed on the bottom surface of the UV-cured synthetic resin, or it may be performed on a first layer of UV-cured synthetic resin followed by printing and curing a second layer of UV-cured synthetic resin on top of the hot-stamped decorative foil.

Using the above-described method to fabricate synthetic resin articles such as buttons, rhinestones and other textile accessories, high energy consumption processes such as injection moulding that involves high temperatures and pressures can be avoided, thereby reducing manufacturing cost. The digitally printed synthetic resin articles require minimal or no post-processing compared to traditional methods of manufacturing buttons and rhinestones that require grinding and/or polishing, thereby reducing or eliminating the introduction of hazardous particulate matter into the air and environment. By using digital inkjet printing, the production rate is significantly increased, thereby reducing manufacturing time, while also allowing complex and intricate decorative images to be included in the synthetic resin articles if so desired.

Whilst there has been described in the foregoing description examples of embodiments of the present invention, it will be understood by those skilled in the technology concerned that many variations and combination in details of design, construction and/or operation may be made without departing from the present invention. For example, while maximum ink intensity has been described above as corresponding to black in a grayscale image of a digital image file to be printed, this can be reversed so that maximum ink intensity corresponds to white and minimum ink intensity corresponds to black in the image of the digital image file to be printed.

1. A synthetic resin article comprising:
a layer of digitally inkjet-printed and ultraviolet light (UV)-cured synthetic resin, the synthetic resin article having a thickness ranging from 0.5 mm to 15 mm and being free from any substrate supporting the layer of digitally inkjet-printed and UV-cured synthetic resin.

2. The synthetic resin article of claim 1, further comprising a decorative layer provided on the layer of digitally inkjet-printed and UV-cured synthetic resin.

3. The synthetic resin article of claim 2, wherein the decorative layer comprises a decorative foil hot-stamped on a bottom surface of the layer of digitally inkjet-printed and UV-cured synthetic resin.

4. The synthetic resin article of claim 2, comprising two layers of digitally inkjet-printed and UV-cured synthetic resin, wherein the decorative layer comprises a decorative foil hot stamped on a top surface of a first of the two layers of digitally inkjet-printed and UV-cured synthetic resin, and a second of the two layers of digitally inkjet-printed and UV-cured synthetic resin digitally printed and UV-cured on a top surface of the layer of decorative foil.

5. The synthetic resin article of claim 2, wherein the decorative layer comprises a decorative image digitally inkjet-printed on a top surface of the layer of digitally inkjet-printed and UV-cured synthetic resin.

6. The synthetic resin article of claim 5, further comprising a further layer of digitally inkjet-printed and UV-cured synthetic resin digitally printed and UV-cured on a top surface of the decorative image.

7. The synthetic resin article of claim 1, further comprising a plurality of through holes and configured as a button.

8. The synthetic resin article of claim 1, wherein a bottom surface of the synthetic resin article is provided with a layer of hot melt adhesive film for adhering the synthetic resin article to textile by application of heat.

9. The synthetic resin article of claim 8, wherein the synthetic resin article is pliable.

10. A method of fabricating a synthetic resin article, the method comprising:
a) providing a flatbed digital inkjet printer with a digital image file for printing with UV-curable synthetic resin ink;
b) providing a non-stick surface on the flatbed digital inkjet printer;
c) digitally inkjet printing a layer of UV-curable synthetic resin ink on the non-stick surface according to the digital image file;
d) UV curing the printed layer of UV-curable synthetic resin ink to form a layer of digitally inkjet-printed and UV-cured synthetic resin; and
e) removing the layer of digitally inkjet-printed and UV-cured synthetic resin from the non-stick surface to obtain the synthetic resin article that is free from any substrate supporting the layer of digitally inkjet-printed and UV-cured synthetic resin.

11. The method of claim 10, wherein the digital image file is obtained by 3D scanning an existing article that is to be replicated in the synthetic resin article.

12. The method of claim 10, wherein step a) comprises providing a number of digital image files for printing with UV-curable synthetic resin ink, and steps c) and d) are performed a number of times corresponding to the number of digital image files.

13. The method of claim 10, wherein each digital image file specifies a number of times that an image in the digital image file is to be printed in order to form a required thickness of the synthetic resin article, and wherein steps c) and d) are performed a number of times corresponding to the specified number of times.

14. The method of claim 10, further including, after step d), fabricating a decorative layer on the layer of digitally inkjet-printed and UV-cured synthetic resin.

15. The method of claim 14, wherein fabricating the decorative layer comprises providing the flatbed digital inkjet printer with a digital decorative image file containing a decorative image for printing with colour ink and digitally inkjet printing the decorative image on the layer of digitally inkjet-printed and UV-cured synthetic resin.

16. The method of claim 15, further comprising repeating steps c) and d) to fabricate a further layer of digitally inkjet-printed and UV-cured synthetic resin over the digitally inkjet-printed decorative image.

17. The method of claim 14, wherein fabricating the decorative layer comprises hot stamping a decorative foil on the layer of digitally inkjet-printed and UV-cured synthetic resin.

18. The method of claim 17, wherein hot stamping the decorative foil is performed on a bottom surface of the layer of digitally inkjet-printed and UV-cured synthetic resin.

19. The method of claim 1, wherein hot stamping the decorative foil is performed on a top surface of the layer of digitally inkjet-printed and UV-cured synthetic resin and the method further comprises repeating steps c) and d) to fabricate a further layer of digitally inkjet-printed and UV-cured synthetic resin over the hot-stamped decorative foil.

20. The method of claim 10, wherein a part of the non-stick surface is contoured according to a design of the synthetic resin article to be fabricated and wherein step c) is performed on the contoured part.

21. The method of claim 10, wherein the digital image file for printing with UV-curable synthetic resin ink comprises a grayscale image and wherein ink intensity of UV-curable synthetic resin ink that is deposited in step c) is directly proportional to grayscale intensity of the part of the grayscale image that is being printed.
